(19) United States
(12) Patent Application Publication
(10) Pub. No.: US 2022/0318347 A1
(43) Pub. Date: Oct. 6, 2022

(54) A DEVICE FINGERPRINT EXTRACTION METHOD BASED ON SMART PHONE SENSOR

(71) Applicant: Beijing Digital Union Web Science and Technology Company Limited, Beijing (CN)

(72) Inventors: Congan Yang, Beijing (CN); Weizhen Wang, Beijing (CN)

(21) Appl. No.: 16/621,640

(22) PCT Filed: Nov. 15, 2019
(86) PCT No.: PCT/CN2019/118627

§ 371 Date: Dec. 11, 2019

(30) Foreign Application Priority Data
Nov. 13, 2019 (CN) 201911106806.8

(51) Int. Cl. G06F 21/32; G06V 40/12; H04L 9/08; G06V 40/13

(52) U.S. Cl. CPC G06F 21/32; G06V 40/1376; H04L 9/0866; G06V 40/1306

(57) ABSTRACT

This invention provides a device fingerprint extraction method based on smart phone sensor, which comprises the following steps: Step I: Data acquisition; Step II: Data preprocessing; Step III: ADC value recovery; Step IV: Gain matrix estimation; Step V: Validity check; Step VI: Device fingerprint ID generation. This invention can accurately extract the device fingerprint and can uniquely identify device when the device fingerprint ID doesn't change when certain devices are sampled for ex-factory setting recovery, machine upgrade and time point testing.

### TECHNICAL FIELD

This invention belongs to the field of mobile terminal. The device fingerprint extraction technology based on smart phone sensor mainly relates to the collection, calculation, verification, calibration and other operations of sensor information of smart phone, in particular to the calculation and verification of bias gain of gyroscope, accelerometer and magnetometer as well as the generation and verification of smart phone device fingerprint.

### BACKGROUND ART

The sensor is an important part of smart phones. Each smart phone contains many sensor elements such as cameras, microphones, light sensors to GPS, gyroscopes and accelerometers which are all based on the technology of MEMA (Mississippi Emergency Management Agency). For a good sensor, accuracy is very important, so device manufacturers usually use factory calibration to compensate for the deviation in the manufacturing process. The calibration data of each sensor can be calculated by analyzing the output data of the sensor and used as the fingerprint of a device.

At present, the smart phones mainly include two operating systems: Android and iOS. The traditional Android system device fingerprints are mainly generated based on the information of IMEI, MAC and ANDROID_ID for extraction and usually be one or more elements; the traditional iOS system device fingerprints are mainly generated based on the values of IDFA, IDFV and OpenUDID for extraction. As Android system is upgrading and Google restricts the access to the values of IMEI and MAC, the traditional fingerprint access can no longer meet the requirements of unique identification devices, and the access to these information requires permission application, which will significantly affect the user experience. In addition, in the low version of Android, these values are also subject to risks such as tampering and misuse; the current iOS system also cannot obtain the device unique fingerprints in the event the ex-factory setting is fully restored, restricting the attribution and traceability of devices.

### CONTENTS OF THE INVENTION

This invention is realized by the technical scheme as follows.

With the purpose to solve these problems, this invention proposes a device fingerprint extraction technology based on smart phone sensor information. To achieve the above purpose, the first embodiment of this invention proposes a device fingerprint extraction method based on smart phone sensor, which includes the steps as follows:

Step I: data acquisition;

Step II: data preprocessing;

Step III: ADC value recovery;

Step IV: gain matrix estimation;

Step V: validity check

Step VI: Device fingerprint ID generation

With the purpose to achieve the above purpose, the second embodiment of this invention proposes an electronic device, comprising the memory, the processor and the computer program stored on the memory and capable of running on the processor, which will be executed to realize the method mentioned when the processor operates the computer program.

With the purpose to achieve the above purpose, the third embodiment of this invention proposes a computer-readable storage medium on which a computer program is stored, which will be executed to realize the method mentioned when the processor operates the computer program. This invention has the advantages that: it can extract device fingerprint exactly, and can uniquely identify device when the device fingerprint ID doesn't change when certain devices are sampled for ex-factory setting recovery, machine upgrade and time point testing.

### BRIEF DESCRIPTION OF THE DRAWINGS

By reading the details of the selected execution modes below, the common technicians of this field will be clear of all advantages of this invention. The figures can only be used to show the purpose of the selected execution modes rather than to restrict this invention. Over the whole figures, the same reference symbols represent the same parts. In the figures:

FIG. 1 shows the flow chart of a device fingerprint extraction method based on smartphone sensor according to the execution modes of this invention;

FIG. 2 shows the typical diagram of sensor acquisition data according to the execution modes of this invention;

FIG. 3 shows the structural diagram of an electronic device provided by an embodiment of this invention;

FIG. 4 shows the schematic diagram of a computer medium provided by an embodiment of this invention.

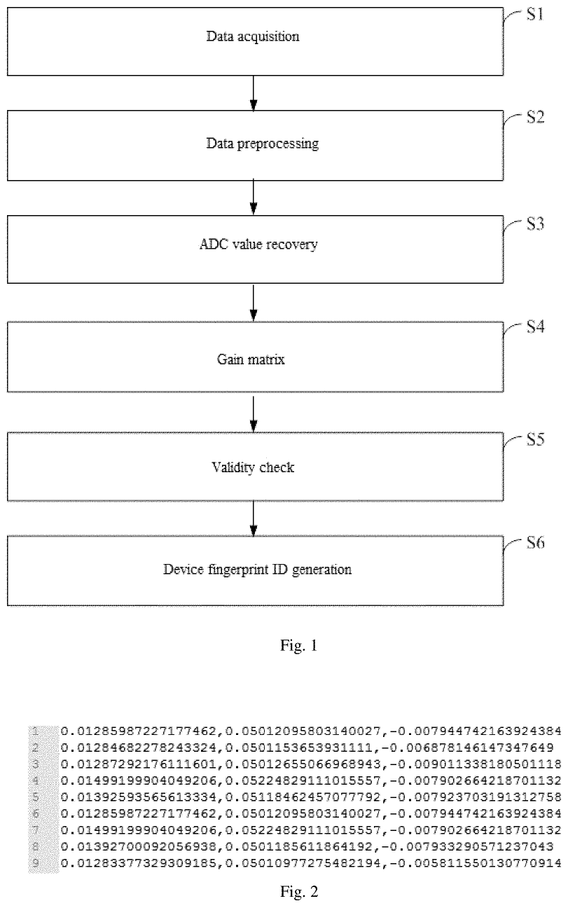

### EMBODIMENTS

We will describe the typical execution modes in detail with the reference to the figures. Though the figures show the typical execution modes of this invention, we shall understand that this invention can be realized in all forms rather than be restricted by the execution modes herein. On the contrary, these execution modes are provided with the purpose to make this invention more understandable and transmit the scope of this invention to the technicians of this field.

Noted that unless otherwise specified, the technical terms or scientific terms used in this invention shall be the general meaning understood by the technicians of this field.

In addition, the terms “first”, “second” and the like are used to distinguish different objects rather than to describe a particular order. In addition, the terms “include”, “have” and their deformations are intended to cover the non-exclusive inclusions. For example, the processes, methods, systems, products or devices that contain a series of steps or units are not limited to the listed steps or units, but optionally also include the steps or units that are not listed, or optionally include other steps or units that are fixed to these processes, methods, products or devices.

During the work, this invention can infer the ex-factory calibration data through the outputs from gyroscope, accelerometer, magnetometer and other sensors and construct a valid device fingerprint which can effectively identify the device uniqueness with these calibration data. The reason why this invention uses the sensor information is that the access to these data needn't permission application and is available in both Android and iOS systems with high efficiency, the acquisition of sample data can be completed within 1 s and the fingerprint information extracted will not change as time goes and along with the ex-factory setting recovery, update, upgrade and other operations. This invention proves that the method hereunder can generate the unique fingerprint of a device.

The method adopted in this invention is to infer the ex-factory calibration data of each device according to the outputs of gyroscope, accelerometer, magnetometer and other sensors. MEMS sensors usually convert analog quantity into digital quantity by ADC and store it in register. For three-axis motion sensor, the outputs of ADC are generally expressed as follows: A=[Aₓ, A_{y}, A_{z}]^{T}. According to the calibration model of standard sensors, the standard outputs of sensors can be expressed as follows:

$$( \begin{matrix}{O}_{x} \\ {O}_{y} \\ {O}_{z}\end{matrix} ) = [ \begin{matrix}{P}_{x} & 0 & 0 \\ 0 & {P}_{y} & 0 \\ 0 & 0 & {P}_{z}\end{matrix} ] [ \begin{matrix}{N}_{xx} & {N}_{xy} & {N}_{x z} \\ {N}_{yx} & {N}_{yy} & {N}_{y z} \\ {N}_{zx} & {N}_{zy} & {N}_{zz}\end{matrix} ] [ \begin{matrix}{A}_{x} \\ {A}_{y} \\ {A}_{z}\end{matrix} ] + [ \begin{matrix}{D}_{x} \\ {D}_{y} \\ {D}_{z}\end{matrix} ]$$

Wherein, PᵢϵP refers to the scale factor; NᵢⱼϵN refers to the non-orthogonality between axes i and j; BᵢϵB refers to the standard deviation; A refers to the sensitivity or gain of the sensor, which is defined as the ratio between the output signal and the measurement attribute, and the nominal gain of the sensor is the expected working sensitivity of the sensor. In this invention, M is used to represent the nominal gain of the sensor. If the sensor is ideal, its scale matrix P and non-orthogonality matrix N shall respectively be M·I and I, wherein I is the unit matrix. So the above equation can be further simplified as:

O=HA+D

Wherein, H=PN represents nominal gain. The calibration standard of the sensor has multi latitudes, including high-precision device, multi position, Kalman filter and vision based. Manufacturers usually choose to only calibrate the offset vector to reduce costs. After the factory calibration is completed, these calibration data will be written into the hardware storage, and will not change as time goes nor readily rewritten.

After the device is calibrated in the factory, the gain matrix H and bias matrix D shall be unique, so any one of these two data can be recovered as the fingerprint of the device. The embodiments of this invention describe the recovery of the gain matrix H. With the purpose to recover the gain matrix, the invention needs to know the nominal gain of each sensor device which can be generally found in the sensor device specification of the manufacturer, for example, the nominal gain of the gyroscope of HUAWEI Mate 30 is 60 MDPs, that of iPhone X is 61 MDPs and that of Google Pixel3XL is 64 mdps. The bias matrix D can be eliminated by the difference between the two sensors. The actual gain matrix and the ideal gain matrix are very similar, but not equal.

The basic method for generating sensor fingerprint of this invention includes six steps: data acquisition, data preprocessing, ADC value recovery, gain matrix estimation, validity check, and device fingerprint ID generation. When the device is static or slowly moving, it can generate sensor fingerprint effectively. The invention will take the fingerprint generated by gyroscope data as an example below.

### Embodiment 1

Step I: Data Acquisition

First of all, we can write an application app and acquire gyroscope sensor information on the device. Through the test of this invention, the acquisition efficiency on different models of Android device is different. About 400 groups of data can be acquired in HUAWEI Mate 30 one second and about 100 groups in GooglePilel3XL one second, and about 110 groups in iOS device one second. It is enough to acquire 100 groups of data herein. O=[O₀, O₁, . . . , Oₙ₋₁] is used to identify the number of single groups of data and Oᵢ=[Oₓ, O_{y}, O_{z}]^{T} represent the access to different axes.

Step II: Data Preprocessing

After obtaining the data, we can firstly carry out the differential calculation on the data to eliminate the offset matrix error D, and get ΔO by the equation as follows:

ΔO=[O₁, O₂−O₁, . . . Oₙ₋₁−Oₙ₋₂].

Step III: ADC Value Recovery

In this step, this invention mainly recovers ΔA which is the difference among successive ADCs. ΔA can be obtained from the ΔA=H⁻¹ΔO. H⁻¹ is the inverse matrix of the actual gain matrix H, but the actual gain matrix is unknown herein, so the nominal gain can be temporarily replaced by the actual gain value in this invention: H₀=M^{H}·I. M_{H} is the nominal gain of the gyroscope, and the value can be obtained from the manufacturer. Herein, this invention only takes the integer value of ΔA, and it can be estimated by the equation as follows:

Δ̅A=round(H₀⁻¹ΔO) (1)

At this time, H₀ is not equal to H but an estimated value, so Δ̅A is not really the data to be obtained. This invention also needs to eliminate the invalid value through the equation as follows:

E_{ΔA}^{r}=|Δ̅A−H₀⁻¹Δo| (2)

With the purpose to assure the accuracy of the data, it is necessary to eliminate the data beyond the threshold value. At this time, the threshold value can be set to 0.1. The values can be eliminated according to the ADC values and the last remaining ADC value can be regarded as real data. At this time, the absolute value of ΔA is very small, and can be only used in the state of static or slow movement.

Step IV: Gain Matrix Estimation

After obtaining the ADC value ΔA, this invention can estimate the nominal gain H̅ by the equation as follows:

H̅=ΔO/ΔA

In this case, the matrix right division will return the least square solution of H, namely HΔ̅A=ΔO.

Step V: Validity Check

With the purpose to quantify the deviation of H̅ from the true H, this invention calculates by the equation as follows:

E^{e}=std(ΔO−H̅ΔA)

The std herein is the standard deviation function. If the error is very small, the value of H̅ will be very close to the true H.

Herein, we take HUAWEI Mate 30 as an example, and will obtain the value of H̅ as follows:

$$[ \begin{matrix}0.001065797050075 & - 0.000010120011969 & - 0.00000479368988 \\ 0.000002929477149 & 0.001071656004373 & 0.000003994741566 \\ 0.000007989483132999999 & 0.000006924218716 & 0.001070058107746\end{matrix} ]$$

The ADC resolution of Mate30 is 16 bits. This invention can convert rds to dps and estimate the integer value:

$$\tilde{H} \cdot {2}^{16} \cdot 180 / π = [ \begin{matrix}4002.000 \; 000021879 & - 37.99999999747552 & - 17.999999998606565 \\ 10.99999999956567 & 4024.000000021010 & 14.999999996335514 \\ 29.99999999642596 & 25.9999999 \; 9965612 & 4018.0000000202235\end{matrix} ]$$

We can see that in this case, these numbers are very close to integers, so we can round them to get the true gain matrix H. With the purpose to ensure reliability, this invention needs to calculate the error:

E_{H}^{r}=|H̅^{d}·2¹⁶−round(H̅^{d}·2¹⁶)|

The H̅^{d} wherein is the value of H̅ when its unit is dps. At this time, the error range of E obtained can be 0.01. When the error is greater than this value, it means that the group of data is unavailable, and the current device may be in a moving state. In this case, this invention needs to re-acquire data to calculate until the error reaches a certain degree.

Step VI: Device Fingerprint ID Generation

The generation of fingerprint ID can be obtained according to the following formula:

DeviceID=round(H̅^{d}·2¹⁶)−round(H₀^{d}·2¹⁶)

It can be said that the DeviceID is the gain matrix H after the nominal gain is extracted in the unit of dps. The DeviceID of HWAWEI Mate 30 is exampled as follows:

$$DeviceID = [ \begin{matrix}4 & - 38 & - 18 \\ 11 & 27 & 15 \\ 30 & 26 & 22\end{matrix} ]$$

The idea and process of generating device fingerprint ID of gyroscope are basically described herein. Generally speaking, these steps are realizable, but they require that the device is in a state of static or slow movement when it is measured. With the purpose to solve this problem, this invention has studied an improvement scheme which solves the device fingerprint extraction when the device is moving. See the embodiment 2 as follows.

### Embodiment 2

In the Formula I in Step III, this invention estimates ΔA by H₀=M_{H}·I, but because H₀ is not equal to H, the rounded value of ΔA is not equal to the actual value of ΔA. Generally, as the element value in H₀ increases, the difference between ΔO and H₀·ΔA will increase, resulting in incorrect rounding. In the improvement method, in addition to data preprocessing, ADC value recovery and gain matrix estimation, this invention uses the same scheme as that of the basic steps. Herein, this invention does not directly use ΔO to input algorithm, but uses the data within different ranges to update and iterate H. The specific steps are as follows:

Step I: Data Acquisition

First of all, we can write an application app to acquire gyroscope sensor information on the device. After the test by this invention, the acquisition efficiency of different models of Android device is different. About 400 groups of data can be acquired in HUAWEI Mate 30 one second, about 100 groups in GooglePilel3XL one second, and about 110 groups in iOS device one second. It is enough to acquire 100 groups of data herein. This invention is used to identify the number of single groups of data and to represent the access to different axes.

Step II: Data Preprocessing

Herein, this invention can firstly generate data with a smaller value from ΔO, because the smaller value is unlikely to exceed the rounded error, so this invention can sort the elements in ΔO, and then remove the difference between adjacent elements, so the result value will be very small. The data obtained can be expressed as O=[O₀, O₁, . . . , Oₙ₋₁], wherein, Oᵢ=[Oₓ, O_{y}, O_{z}]^{T} represents single axis data. First, the values of ΔOᵢₓ can be sorted in ascending order, and [66 O]ₓ represents the sorted array. Similarly, this invention can sort the values of [ΔO]_{y} and [ΔO]_{z}, and output the results, and then calculate as follows:

ΔΔO=[diff([ΔO]x)diff([ΔO]y)diff([O]z)] (3)

The diff function uses different continuous vectors in the matrix. For example, the calculation formula of diff(ΔO) is:

diff(ΔO)=[ΔO₁−ΔO₀, . . . , ΔOₙ₋₁−ΔOₙ₋₂]

By subtracting similar vectors, ΔΔO contains more data of smaller values. According to the Equation 1, this invention can obtain:

H⁻¹diff(ΔO)=diff(ΔA)

Herein, the values of diff (ΔA) are all integers. Combined with the Formula 3, we can see that the values of HA shall only contain integers. Therefore, this invention can directly add ΔΔO to ΔO, and can perform this extension repeatedly to generate more smaller values. Then, according to the range of values, this invention can generate multiple batches of data from the extended data and update them. The absolute values of all elements are lower than the products of programming gains, that is to say:

ΔO^{εi}={ΔOⱼϵΔO|max(|ΔOⱼ|<(εᵢ+0.5)M_{H}}

We can calculate as such batches and then double the value of each batch until it is the same as the value of ΔO. Then we can calculate ΔO^{εi} step by step and update the value of H.

Step III: ADC Value Recovery

Herein, this invention does not use H₀ to estimate ΔA and round the error E_{ΔA}^{r}, but uses H₀ of the initial value to replace H̅, so the above Formulas 1 and 2 shall be updated as follows:

Δ̅A^{ϵi}=round (H̅⁻¹ΔO^{ϵi})

E_{ΔA}_{^{ϵi}}^{r}=Δ̅A^{ϵi}=H̅⁻¹ΔO^{ϵi}|

Step IV: Gain Matrix Estimation

This step is mainly to update H̅ from ΔO^{ϵi} zone of each batch of data. The main difference between the improvement method and the basic method is that the former can return to the data preprocessing step after the gain matrix estimation. After each update of H̅, the algorithm will check whether ΔO^{ϵi}=ΔO is tenable. If yes, it means that this invention has processed all the output data and passed the estimated H̅ to the validity check process. Otherwise, the algorithm will return to the pre-processing stage by using the updated H̅, and double filter ordinal for the next batch of data processing.

The improvement method is to iterate from smaller range of data to the whole data set, and estimate the output value of ADC through the estimated value, thus reducing the error of each estimation, so the device ID can be generated even when the device is moving. The basic method can show the feasibility of the sensor fingerprint, and the improvement method is applicable to actual scenarios and more reliable, which is the preferred way to obtain the device fingerprint in the actual situation.

Step V: Validity Check

With the purpose to quantify the deviation of H̅ from the true H, this invention calculates by the equation as follows:

E^{e}=std(ΔO−H̅ΔA)

The std herein is the standard deviation function. If the error is very small, the value of H̅ will be very close to the true H.

Herein, we take HUAWEI Mate 30 as an example, and will obtain the value of H̅ as follows:

$$[ \begin{matrix}0.001065797050075 & - 0.000010120011969 & - 0.00000479368988 \\ 0.000002929477149 & 0.001071656004373 & 0.000003994741566 \\ 0.000007989483132999999 & 0.000006924218716 & 0.001070058107746\end{matrix} ]$$

The ADC resolution of Mate30 is 16 bits. This invention can convert rds to dps and estimate the integer value:

$$\tilde{H} \cdot {2}^{16} \cdot 180 / π = [ \begin{matrix}4002.000 \; 000021879 & - 37.99999999747552 & - 17.999999998606565 \\ 10.99999999956567 & 4024.000000021010 & 14.999999996335514 \\ 29.99999999642596 & 25.9999999 \; 9965612 & 4018.0000000202235\end{matrix} ]$$

We can see that in this case, these numbers are very close to integers, so we can round them to get the true gain matrix H. With the purpose to ensure reliability, this invention needs to calculate the error:

E_{H}^{r}=|H̅^{d}·2¹⁶−round(H̅^{d}·2¹⁶)|

The H̅^{d} herein is the value of H̅ when its unit is dps. At this time, the error range of E obtained can be 0.01. When the error is greater than this value, it means that the group of data is unavailable, and the current device may be in a moving state. In this case, this invention needs to re-acquire data to calculate until the error reaches a certain degree.

Step VI: Device Fingerprint ID Generation

The generation of fingerprint ID can be obtained according to the following formula:

DeviceID=round(H̅^{d}·2¹⁶)−round(H₀^{d}·2¹⁶)

It can be said that the DeviceID is the gain matrix H after the nominal gain is extracted in the unit of dps. The DeviceID of HWAWEI Mate 30 is exampled as follows:

$$DeviceID = [ \begin{matrix}4 & - 38 & - 18 \\ 11 & 27 & 15 \\ 30 & 26 & 22\end{matrix} ] .$$

Test Results

After real device test, this invention found different device manufacturers take insufficient effort in the calibration of sensors. The manufacturers will not conduct calibration and verification of MEMS for cheap and low-end smart phones while certain Android manufacturers only conduct calibration on certain types such as HUAWEI Mate and Google Pixel. But the factories of iOS devices have conducted calibration since the time of iPhone4 and iPad3. This invention can accurately extract device fingerprints for the devices with the original sensors calibrated by factories. According to the statistics of this invention, this invention can extract the device fingerprint IDs with the accuracy rate of 100% after it tests 5,680 Android devices and 4,675 iOS devices. In addition, certain devices have been sampled for ex-factory setting recovery, machine upgrading and time point test, showing no change in the device fingerprint IDs and uniqueness in device identification.

The execution modes of this invention also provide the electronic devices corresponding to the device fingerprint extraction method based on smart phone sensor provided by the aforesaid execution modes so as to execute the device fingerprint extraction method based on smart phone sensor. Such devices may be mobile phones, tablet computers and cameras, which are not stipulated in the embodiments of this invention.

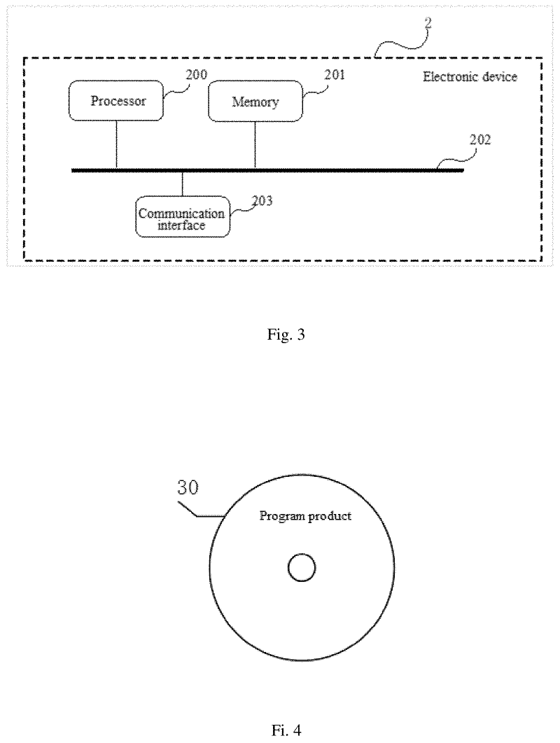

With the reference to FIG. 3 which is the schematic diagram of the electronic devices provided by certain execution modes of this invention, the electronic device 2 comprises the processor 200, the memory 201, the bus 202 and the communication interface 203, and the processor 200, communication interface 203 and the memory 201 are connected through the bus 202; the memory 201 stores the computer program which can run in the processor 200 and the processor 200 will execute the device fingerprint extraction method based on smart phone sensor provided by any execution mode of this invention when it operates the computer program.

Thereof, the memory 201 may contain high-speed random access memory (RAM) and/or non-volatile memory which may be minimum one disk memory. The system network element may be communicated with minimum the other network element through minimum one communication interface 203 (wire or wireless), making the Internet, WAN, local network and MAN available.

The bus 202 may be ISA bus, PCI bus and EISA bus. The bus can be divided into address bus, data bus, control bus, etc. The memory 201 is used for storing programs, and the processor 200 will execute the programs after receiving the execution instructions. The device fingerprint extraction method based on smart phone sensor disclosed in any execution mode of this invention can be applied to or executed by the processor 200.

The processor 200 may be a kind of integrated circuit chip with signal processing capability. During the execution, each step of the above method can be completed through the integrated logic circuit of the hardware or the instruction in the form of software in the processor 200. The above processor 200 can be general-purpose processor, comprising central processing unit (CPU), network processor (NP), etc.; or a digital signal processor (DSP), ASIC, FPGA or other programmable logic device, discrete gate or transistor logic device, and discrete hardware component, which can realize or execute all methods, steps and logic block diagrams in the embodiments of this invention. The general-purpose processor may be a microprocessor or any conventional processor, which can directly present the completion by the hardware decode processor or by the module of hardware and software in the decode processor combined with the steps of the methods disclosed in the embodiments of this invention. The software module can lie in RAM, FM, ROM, ROMP, EEPROM, MTRR and other mature storage mediums of this field which lie in the memory 201. The processor 200 will read the information of the memory 201 and complete the steps of the above methods combined with its hardware.

The electronic devices provided by the embodiments of this invention and the device fingerprint extraction method based on the smartphone sensor provided by embodiments of this invention are of the same inventive concept, and have the same beneficial effect as the method adopted, operated or realized.

The execution modes of this invention also provide a kind of computer-readable mediums corresponding to the device fingerprint extraction method based on the smart phone sensor provided by the aforesaid execution modes. With reference to the FIG. 4, the computer-readable storage medium is CD30 with the computer program (i.e. program product) and will execute the device fingerprint extraction method based on the smart phone sensor provided by any aforesaid execution modes when the computer program is executed by the processor.

Noted that the examples of the computer-readable storage mediums can also include without limitation to, PRAM, SRAM, DRAM, RAM, ROM, EEPROM, FM or other optical and magnetic storage mediums, which is not described herein.

The computer-readable mediums provided by the embodiments of this invention and the device fingerprint extraction method based on the smartphone sensor provided by embodiments of this invention are of the same inventive concept, and have the same beneficial effect as the method adopted, operated or realized by the App stored.

In the description of the specification, the reference terms “an embodiment”, “certain embodiments”, “examples”, “specific examples”, or “certain examples” mean the minimum one embodiment or example contained in this invention combined with the specific features, structures, materials or characteristics described this embodiment or example. In this specification, the schematic expression of the above terms does not have to be directed to the same embodiment or example. Moreover, the specific features, structures, materials or characteristics described may be combined in an appropriate manner in any one or more embodiments or examples. In addition, without contradiction, the technicians of this field can combine and assemble different embodiments or examples described in this specification and features of different embodiments or examples.

In addition, the terms “first” and “second” are used to describe purposes only and cannot be understood as indicating or implying relative importance or implying the number of indicated technical features. Thus, the features defined as “first” or “second” may include minimum one such feature, either explicitly or implicitly. In the description of this invention, “multiple” means minimum two, such as two, three, etc., unless otherwise specifically defined.

Any process or method in the flowchart or described in other ways herein can be understood as representing a module, fragment or part of code including one or more executable instructions for implementing the steps of a custom logic function or process, and the scope of the selected embodiments of this invention includes additional implementation, which may follow the sequence of showing or discussion. The functions can be executed in basic synchronous way or by inverse sequence, which shall be understood by the technicians of the field for the embodiments of this invention.

The logics and/or steps represented in a flowchart or otherwise described herein, for example, the priority list of the executable instructions considered for realizing the logic functions can be realized in any computer-readable medium to serve the instruction execution systems, units or devices (e.g. systems based on computer, systems with processor or other systems which can take instructions for instruction execution systems, units or devices and execute these instructions), or work in combination with these instruction execution systems, units or devices. In terms of this specification, “computer-readable medium” may be any unit that may contain, store, communicate, propagate or transmit programs for use by or in combination with instruction execution systems, units or devices. A more specific example (non-exhaustive list) of a computer-readable medium includes: electrical connection section (electronic unit) with one or more cables, portable computer disk case (magnetic unit), RAM, ROM, EPROM/FM, optical fiber unit, and CD-ROM. In addition, the computer-readable medium may even be the paper or other suitable medium on which a program can be printed. The program can be obtained through optical scanning, editing, decoding or even by electronic processing for the paper or other mediums and stored in the computer memory.

It is understood that all parts of this invention can be implemented by hardware, software, firmware, or a combination of them. In the above execution modes, a plurality of steps or methods may be realized by the software or firmware stored in memory and executed by a suitable instruction execution system. For example, if realized by hardware as the another execution mode, any one of the following technologies disclosed in this field or their combination can be executed: discrete logic circuit with logic gate circuit for realizing logic function of data signal, special integrated circuit with suitable combination logic gate circuit, programmable gate array (PGA) and field programmable gate array (FPGA).

The common technicians of this field can understand that all or part of the steps realizing the methods in the above embodiments can be completed by the hardware under the instructions of a program. The program can be stored in a computer-readable storage medium. When the program is executed, one or all steps of the method in embodiments can be included.

In addition, all functional units in each embodiment of this invention can be integrated into one processing module or be physically independent, or integrated into one module each two or more. The integration in the module can be realized by hardware or by functional module of software. If the post-integration module is realized by the functional module of software and sold or used as an independent product, it can be stored in a computer-readable storage medium. The storage medium mentioned above can be ROM, disk or CD. Although the embodiments of this invention have been shown and described above, it can be understood that the above embodiments are exemplary and cannot be understood as the restrictions of this invention. The common technicians of this field can change, modify, replace and transform the embodiments above within the scope of this invention.

The above mentioned is only a preferred specific execution mode of this invention instead of the whole protection scope of this invention. Any change or substitution that a technician familiar with this technical field can get easily from the technical scope disclosed by this invention shall be covered by the protection scope of this invention. Therefore, the protection scope of this invention shall be subject to the protection scope of the claims.

We claim:

1. A device fingerprint extraction method based on smart phone sensor, featured and including the step as follows:
Step I: data acquisition;
Step II: data preprocessing;
Step III: ADC value recovery;
Step IV: gain matrix estimation;
Step V: validity check;
Step VI: device fingerprint ID generation

2. The device fingerprint extraction method based on smart phone sensor according to claim 1 is featured,
the Step I includes:
collect the data of gyroscope sensor, using O=[O₀, O₁, . . . , Oₙ₋₁] to identify the data of single group number, and use Oᵢ=[Oₓ, O_{y}, O_{z}]^{T} to represent the acquisition of different axes.

3. The device fingerprint extraction method based on smart phone sensor according to claim 2 is featured,
the Step II includes:
after obtaining the data of the gyroscope sensor, we shall firstly perform differential calculation on the data, and obtain ΔO by the equation as follows:
ΔO=[O₁−O₀, O₂−O₁, . . . , Oₙ₋₁−Oₙ₋₂].

4. The device fingerprint extraction method based on smart phone sensor according to claim 3 is featured,
the Step III includes:
recover the difference ΔA among consecutive ADCs and estimate it by the equation as follows:
Δ̅A=round(H₀⁻¹ΔO) (1)
wherein, H⁻¹ is the inverse matrix of the actual gain matrix H i.e. H₀=M_{H}·I, M^{H} is the nominal gain of the gyroscope, and I is the unit matrix;
eliminate the invalid values by the equation as follows:
E_{ΔA}^{r}=|Δ̅A−H₀⁻¹Δ₀| (2).

5. The device fingerprint extraction method based on smart phone sensor according to claim 4 is featured,
the Step IV includes:
estimate the nominal gain H̅ by the equation as follows:
H̅=ΔO/ΔA.

6. The device fingerprint extraction method based on smart phone sensor according to claim 5 is featured,
the Step V includes:
quantify the deviation between H̅ and true H, and calculate it by the equation as follows:
E^{e}=std(ΔO−H̅ΔA)
wherein, std is the standard deviation function;
for error calculation:
E_{H}^{r}=|H̅^{d}·2¹⁶−round(H̅^{d}·2¹⁶)|

wherein, H̅^{d} is the value of H̅ in dps

7. The device fingerprint extraction method based on smart phone sensor according to claim 1 is featured,
the Step VI includes:
generate fingerprint ID according to the formula as follows:
DeviceID=round(H̅^{d}·2¹⁶)−round(H₀^{d}·2¹⁶).

8. The device fingerprint extraction method based on smart phone sensor according to claim 2 is featured,
the Step II includes:
after obtaining the data of the gyroscope sensor, we can express the obtained data as follows:
O=[O₀, O₁, . . . , Oₙ₋₁]
wherein, Oᵢ=[Oₓ, O_{y}, O_{z}]^{T} represents the uniaxial data. We can firstly sort the value of ΔOᵢₓ in ascending order and [ΔO]ₓ represents the sorted array. Similarly, we can sort the values of ΔO_{iy} and ΔO_{iz}, and output the results [ΔO]_{y} and [ΔO]_{z}, and then calculate as follows:
ΔΔO=[diff([ΔO]x)diff([ΔO]y)diff([O]z)] (3)
wherein, the formula of diff(ΔO) is:
diff(66 O)=[ΔO₁−ΔO₀, . . . , ΔOₙ₋₁−ΔOₙ₋₂]
H⁻¹diff(ΔO)=dif(ΔA)
we can directly add ΔΔO to ΔO, perform this expansion repeatedly to generate more data with smaller values, generate multiple batches of data from the expansion data according to the range of values, and update them. The absolute value of all elements shall be lower than the product of programming gains, that is:
ΔO^{εi}={ΔOⱼ_{^{ϵ}}ΔO|max(|ΔOⱼ|)<(εᵢ+0.5)M_{H}}
we can calculate as such batches and then double the values of each batch until it is the same as ΔO; then we can calculate ΔO^{εi} step by step and update the value of H.

9. The device fingerprint extraction method based on smart phone sensor according to claim 8 is featured,
the Step III includes:
recover the difference among consecutive ADCs and estimate it by the equation as follows:
Δ̅A^{ϵi}=round(H̅⁻¹ΔO^{≢i}) (1)
wherein, H⁻¹ is the inverse matrix of the actual gain matrix H, i.e. H₀=M_{H}·I, M^{H} is the nominal gain of the gyroscope, and I is the unit matrix;
eliminate the invalid values by the equation as follows:
E_{ϵi}^{r}|Δ̅A^{ϵi}−H̅⁻¹ΔO^{ϵi}| (2).

10. The device fingerprint extraction method based on smart phone sensor according to claim 9 is featured,
the Step IV includes:
after each update of H̅, check whether ΔO^{ϵi}=ΔO is tenable. If yes, pass the estimated H̅ to the validity check process. Otherwise, return the updated H̅ to the pre-processing stage, and multiply the filter ordinal by 2 for the next batch of data processing.

11. (canceled)

12. (canceled)
